(19) United States
(12) Patent Application Publication
(10) Pub. No.: US 2025/0335742 A1
(43) Pub. Date: Oct. 30, 2025

(54) TIME SERIES ANOMALY DETECTION

(71) Applicant: FANUC CORPORATION, Yamanashi (JP)

(72) Inventors: Yujiao Cheng, Sunnyvale, CA (US); Tetsuaki Kato, Fremont, CA (US)

(21) Appl. No.: 18/645,885

(22) Filed: Apr. 25, 2024

(51) Int. Cl. G06N 3/0455

(52) U.S. Cl. CPC G06N 3/0455

(57) ABSTRACT

A system for anomaly detection in time-series data. A reconstruction-based anomaly detection module is constructed, where a short time Fourier transform (STFT) is performed on time-series data samples, and feature jittering is applied to the STFT frequency component matrix. The STFT matrix after feature jittering is input to an encoder/decoder neural network, where masking is applied before the encoder, along with layer-wise feature embedding. The encoder/decoder neural network output is a reconstructed STFT matrix, which is subtracted from the input STFT matrix to produce a difference matrix, from which an anomaly score is calculated. After training the encoder/decoder neural network with good data samples, feature weighting is employed which optimizes frequency weights applied to the difference matrix to achieve accurate anomaly scores for both good and bad data samples. After training of the encoder/decoder neural network and frequency weighting optimization, the system is used in inference mode for production data.

### BACKGROUND

### Field

The present disclosure relates generally to a reconstruction-based method for anomaly detection and, more particularly, to a method for anomaly detection in time-series data which uses a short time Fourier transform to convert the time-series data to a frequency component input matrix, an encoder/decoder neural network to reconstruct an output matrix, and computes anomaly scores based on a difference between the input and output matrices, where frequency weighting is used to optimize anomaly detection performance.

### Discussion of the Related Art

Anomaly detection is a broad class of computational analysis where some type of input data sample is analyzed to determine whether the data sample represents a normal condition or an anomaly condition. The data sample may be an image of a part, in which case the analysis determines whether the part is normal or an anomaly, or the data sample may be time-series data from an operation, in which case the analysis determines whether the operating conditions are normal or an anomaly.

It is known in the art to use neural network systems, including encoder/decoder neural networks, to perform anomaly detection on data samples. In order for training of neural networks to be manageable, it is necessary to reduce the dimensionality of the input data stream. When the input data is images of parts, feature extraction may be used to reduce the image pixel data to a matrix of features having lower dimensions. However, other types of input data present different challenges for dimensionality reduction.

Another fundamental challenge in anomaly detection is a data imbalance between input data representing “good” objects/processes and input data representing “bad” objects/processes. That is, the number of good objects/processes used to train the neural network system typically far outweighs the number of bad objects/processes. This can make it difficult for the neural network to construct a model which accurately distinguishes between characteristics of good and bad objects and processes.

Techniques are known in the art which attempt to improve on the effectiveness of anomaly detection systems. These techniques range from simple adjustment of a threshold between good and bad scores, to adaptation of neural network classifiers, to one-at-a-time filter weighting in feature vector calculations. However, none of these existing techniques have proven to be flexible in adaptation and effective in improving anomaly detection results, particularly for applications where the input data stream is time-series data.

In view of the circumstances described above, improved methods are needed for anomaly detection from time-series input data where a single anomaly data point may be difficult to detect using existing techniques.

### SUMMARY

The following disclosure describes a method and system for anomaly detection from time-series input data. A reconstruction-based anomaly detection module is constructed, where a short time Fourier transform (STFT) is first performed on the time-series data samples, and then random and static feature jittering is applied to the STFT matrix of frequency component magnitude per time segment. The STFT matrix after feature jittering is input to an encoder/decoder neural network, where random and dynamic masking is applied before the encoder, and layer-wise feature embedding is employed. The output of the encoder/decoder neural network is a reconstructed STFT matrix, which is subtracted from the input STFT matrix to produce a difference matrix, from which an anomaly score is calculated. After training the encoder/decoder neural network with good data samples, a feature weighting technique is employed which optimizes frequency weights applied to the difference matrix in order to achieve the most accurate anomaly scores for both good and bad data samples. After training of the encoder/decoder neural network and frequency weighting optimization, the complete anomaly detection system is used in inference mode for production data.

Additional features of the present disclosure will become apparent from the following description and appended claims, taken in conjunction with the accompanying drawings.

### BRIEF DESCRIPTION OF THE DRAWINGS

FIG. 1 is a block diagram illustration showing a basic architecture of an anomaly detection system, as known in the art;

FIG. 2 is a block diagram illustration of a reconstruction-based anomaly detection system, according to embodiments of the present disclosure;

FIG. 3 is a schematic illustration of a machining system wherein vibration data is recorded which can be analyzed using a time-series anomaly detection technique, according to an embodiment of the present disclosure;

FIG. 4 is a block diagram illustration of an anomaly detection system configured for offline learning, where a reconstruction-based anomaly detection module with an encoder/decoder neural network is trained on good time-series data samples, according to an embodiment of the present disclosure;

FIG. 5 is an illustration of the results of a short time Fourier transform (STFT) performed on a time-series data sample, as known in the art;

FIG. 6 is an illustration of a technique for computing an anomaly score from a difference between input and reconstructed STFT matrices, according to an embodiment of the present disclosure;

FIG. 7 is a block diagram illustration of an anomaly detection system configured for feature weighting, where both good and bad data samples are provided to the reconstruction-based anomaly detection module of FIG. 4 and feature weights are determined which optimize anomaly score results, according to an embodiment of the present disclosure;

FIG. 8 includes graphs of frequency weights for X, Y and Z time-series data signals as determined by the feature weighting technique depicted in FIG. 7, according to an embodiment of the present disclosure;

FIG. 9 is a block diagram illustration of an anomaly detection system configured for online testing in inference mode, where operational data samples are provided to the trained anomaly detection module of FIG. 4 and optimized frequency weights are used to determine an anomaly score and a classification, according to an embodiment of the present disclosure; and

FIG. 10 is a flowchart diagram of a method for reconstruction-based time-series anomaly detection, including training an encoder/decoder neural network and optimizing frequency weights used for computing an anomaly score, according to embodiments of the present disclosure.

### DETAILED DESCRIPTION OF THE EMBODIMENTS

The following discussion of the embodiments of the disclosure directed to a reconstruction-based method for time-series anomaly detection is merely exemplary in nature, and is in no way intended to limit the disclosed techniques or their applications or uses.

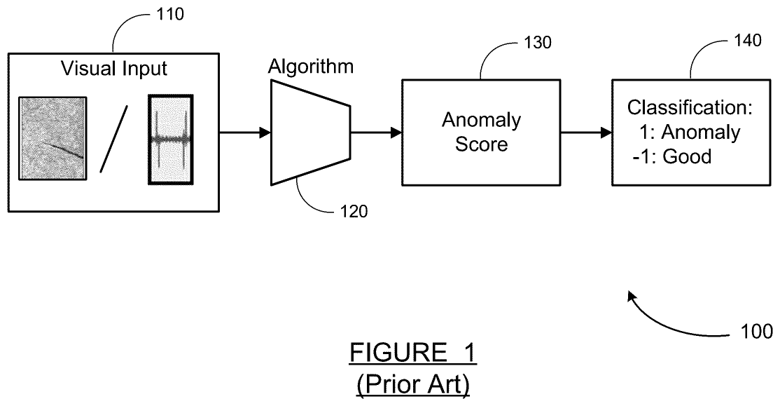

FIG. 1 is a block diagram illustration showing a basic architecture of an anomaly detection system 100, as known in the art. At block 110, an input is provided. The input at the block 110 may be a visual input, such as an image of a part or workpiece. In some applications, the input is graphical or data input, such as data from an accelerometer or other sensor which characterizes the operation of a device. In any case, the input at the block 110 is used to determine whether the item being analyzed (the part/workpiece, or machine/device) is normal (a.k.a., “good”, “ok”, “nominal”) or an anomaly (“bad”, “defect”).

The input from the block 110 is provided to an algorithm 120 which determines an anomaly score 130. Based on the anomaly score 130, the item being analyzed is classified as either normal/good or anomaly/bad at box 140. The algorithm 120 may be any suitable computational algorithm or other type of analyzer such as a machine learning system.

FIG. 1 is simply meant to illustrate the basic concepts and building blocks of anomaly detection systems, to provide a background for the further discussion below. Anomaly detection performed with the system 100 of FIG. 1 may be effective with some types of inputs, but may struggle to identify anomalies or falsely identify anomalies when processing some other types of inputs.

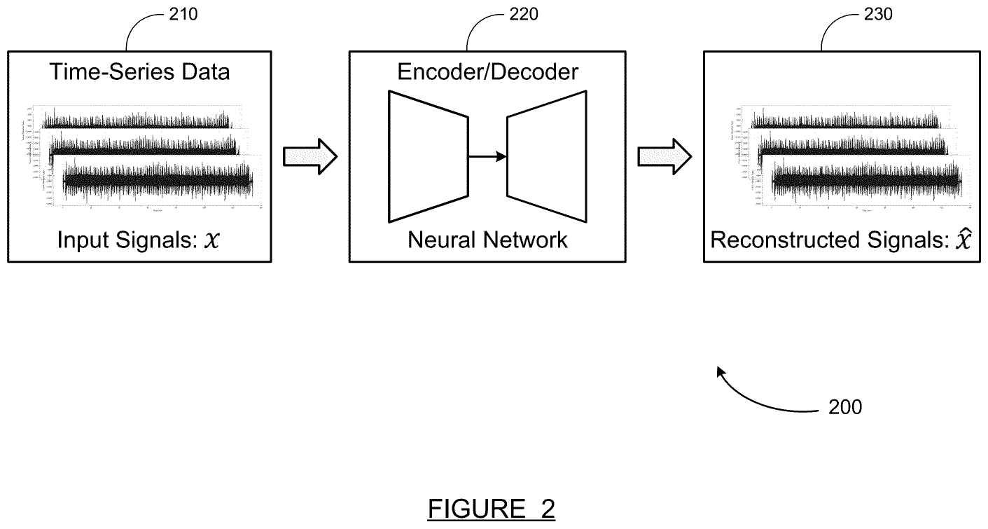

FIG. 2 is a block diagram illustration of a reconstruction-based anomaly detection system 200, according to embodiments of the present disclosure. The system 200 uses an encoder/decoder neural network 220 to transform input signals x in a block 210 to reconstructed signals x in a block 230. In the embodiments of the present disclosure, the input signals x are comprised of time-series data; this will be discussed in detail below. The encoder/decoder neural network is trained in a supervised learning process using a large number of known good data samples. After training, the system is run in inference mode, where the difference between the input signals x and the reconstructed signals x is computed and used to determine whether a sample is good or an anomaly.

FIG. 2 depicts the basic concept of reconstruction-based time-series anomaly detection at a high level. The following figures and the accompanying discussion provide details of specific time-series anomaly detection techniques developed to detect anomalies in time-series data such as that collected from machine tool operations.

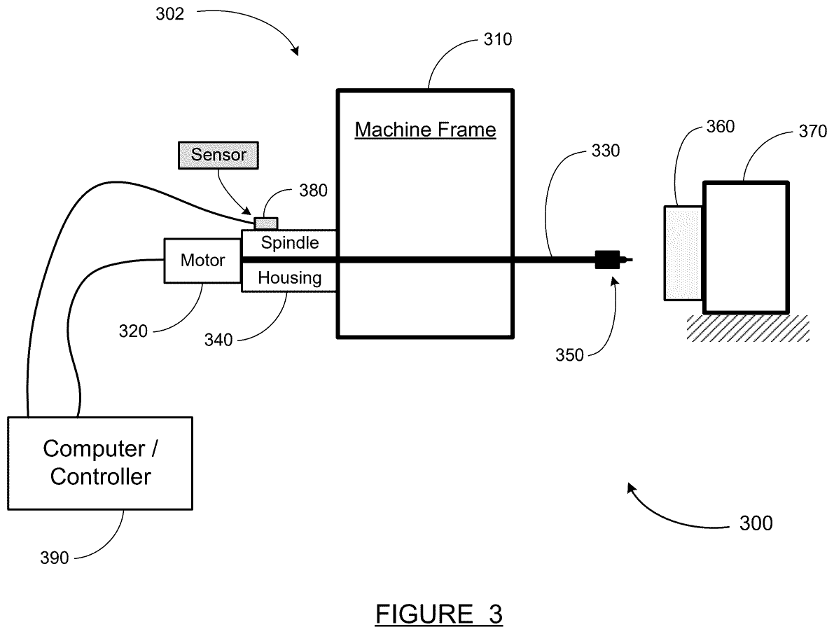

FIG. 3 is a schematic illustration of a machining system 300 wherein vibration data is recorded which can be analyzed using a time-series anomaly detection technique, according to an embodiment of the present disclosure. A machine tool is shown generally at 302. The machine tool 302 includes a machine frame 310 and a motor 320 driving a spindle 330. The spindle 330 is mounted by bearings allowing spindle rotation in a spindle housing 340, to which the motor 320 is coupled. At an end of the spindle 330 opposite the motor 320 is a tool 350. The tool 350 performs a machining operation on a workpiece 360 which is mounted on a fixture 370.

A sensor 380, such as a three-axis accelerometer, is mounted on the spindle housing 340 to measure vibrations. A computing device 390—typically a machine controller—controls the operation of the machine tool 302, such as by positioning the tool 350, controlling the speed of the motor 320, etc. The computing device 390 also receives signals from the motor 320 and the sensor 380. For example, the computing device 390 may record motor speed time-series data, motor torque command time-series data, or other time-series data indicative of motor operating performance. This time-series data from the motor may contain fluctuations or variations which indicate abnormal conditions in the machine tool 302. The computing device 390 also records time-series acceleration data from the sensor 380, such as independent acceleration signals in each of the local X, Y and Z directions, where the sensor data may also contain information indicating machine tool abnormalities.

The time-series data recorded by the computing device 390 is exemplary of the type of data which may be analyzed using the techniques discussed below, providing an indication of whether the machine tool 302 is operating normally or whether an anomaly condition exists. Analysis of the time-series data using the presently disclosed techniques may detect an anomaly condition when no other indication of a problem (such as increased noise or vibration, or visible damage) is outwardly apparent.

The time-series anomaly detection techniques discussed below—including training of the neural network system and operation of the neural network system in inference mode—are of course performed on a computing device. The computing device which performs the time-series anomaly detection computations may be the computing device 390 (i.e., the machine controller), or may be a different computer which receives the time-series data from the computing device 390.

FIG. 3 is simply a high level schematic illustration of a physical system to which the time-series anomaly detection techniques of the present disclosure may be applied. The presently disclosed techniques may also be applied to different types of machining systems, including multi-axis machine tools, robotically-manipulated mills and drills, etc. Furthermore, machine tools are just one non-limiting example of a system where time-series data may be generated and used for anomaly detection according to the disclosed techniques. Many other types of systems, mechanical and otherwise, may be envisioned where the disclosed techniques are equally applicable to time-series data.

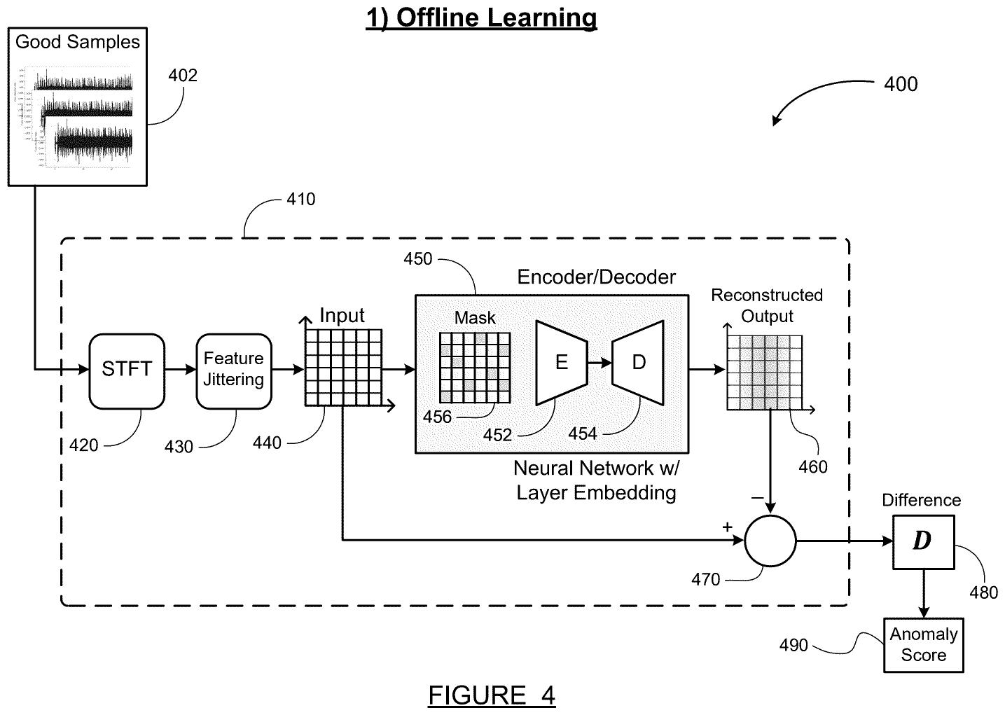

FIG. 4 is a block diagram illustration of an anomaly detection system 400 configured for offline learning, where a reconstruction-based anomaly detection module with an encoder/decoder neural network is trained on known good time-series data samples, according to an embodiment of the present disclosure. Time-series data samples are provided in a box 402. In a preferred embodiment, the samples provided in the box 402 are known good data samples—that is, time-series data from normal operating conditions of the machine tool or other system represented by the time-series data.

A reconstruction-based anomaly detection module 410 receives the data samples from the box 402. In order to reduce the dimensionality of the time-series data samples, a short term Fourier transform (STFT) is first performed on each time-series data sample at box 420. STFT is a technique which breaks a time-series data signal into a plurality of sequential time segments, and performs a Fourier transform of each time segment to determine the frequency component content of each time segment.

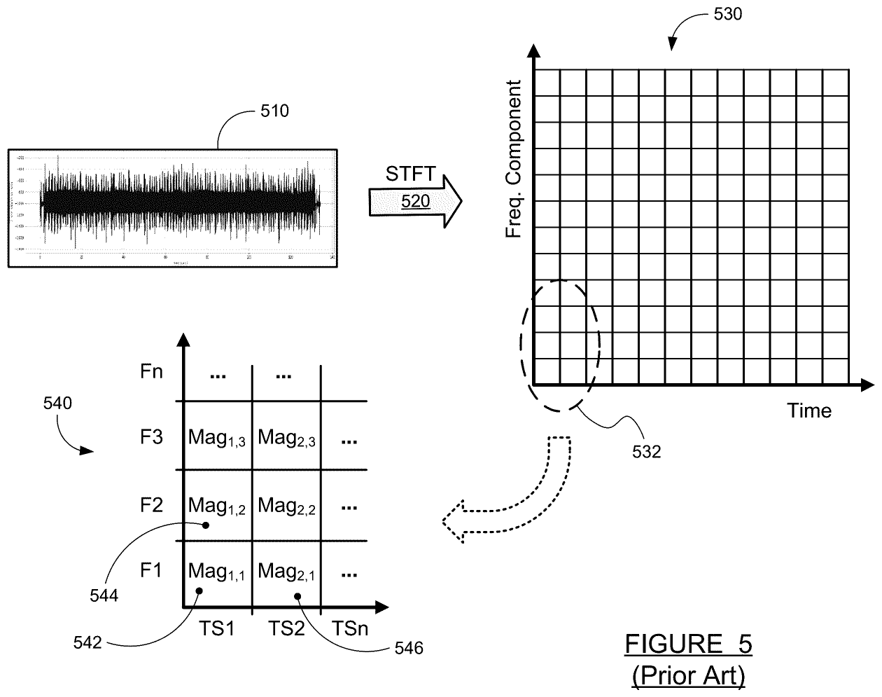

FIG. 5 is an illustration of the results of a short time Fourier transform (STFT) performed on a time-series data sample, as known in the art. An individual time-series data sample is provided in box 510. This corresponds with one of the known good training samples from the box 402 of FIG. 4. The STFT operation is performed on the data sample from the box 510, as indicated at arrow 520. The result of the STFT operation is an STFT matrix 530 which contains magnitude data for a plurality of frequency components (on the vertical axis) at each time segment of a plurality of time segments (on the horizontal axis).

In one exemplary embodiment, the time-series data samples have a time duration of about 10 seconds or more, with a sampling rate of 2000 Hertz (Hz), and the time segment duration for the STFT was defined as 112 milliseconds (ms). The STFT produced frequency components ranging from 0 to 500 Hz, divided into 128 frequency components. Thus, as an example, the STFT matrix 530 may have a size of about 50 time segments (on the horizontal axis) by 128 frequency components (on the vertical axis). The number of frequency components and the time segment duration may be chosen to suit application requirements.

An ellipse 532 defines a portion of the STFT matrix 530 which is magnified in an inset 540. In the inset 540 it can be seen that the horizontal axis is divided into a sequence of time segments (TS1, TS2, etc.), and the vertical axis is divided into a set of frequency components (F1, F2, F3, etc.). Each cell of the matrix 530 contains a magnitude value corresponding to the particular frequency component at the particular time segment. For example, the bottom left cell shown in the inset 540 (cell 542) contains the magnitude for Time Segment 1 at Frequency Component 1 (Mag_{1,1}). The next cell up in the inset 540 (cell 544) contains the magnitude for Time Segment 1 at Frequency Component 2 (Mag_{1,2}). The cell to the right of the cell 542 in the inset 540 (cell 546) contains the magnitude for Time Segment 2 at Frequency Component 1 (Mag_{2,1}), and so forth.

Using the techniques of the present disclosure discussed in detail below, the frequency component magnitude data depicted in the STFT matrix 530 and the inset 540 will be processed in a way which produces anomaly scores with higher accuracy and recall than can be provided by existing anomaly detection techniques.

Returning to FIG. 4, the STFT operation is performed on each time-series data sample at the box 420, producing an STFT matrix of the type described with respect to FIG. 5. At box 430, feature jittering is performed on the STFT matrix. The feature jittering at the box 430 applies a random variation to each cell in the STFT matrix. In a preferred embodiment, the feature jittering at the box 430 is static, meaning that the same random variation is applied to each time-series data sample that is used for training. Feature jittering is a technique which helps to resolve the “identical shortcut” in reconstruction-based neural network systems.

The STFT matrix after feature jittering is defined as an input STFT matrix 440. An encoder/decoder neural network 450 processes the input STFT matrix 440 and provides a reconstructed output STFT matrix 460. The encoder/decoder neural network 450 includes an encoder 452 and a decoder 454, where the encoder/decoder pair is sometimes referred to as a transformer. An encoder/decoder is a type of neural network architecture that is used for sequence-to-sequence learning. The encoder 452 processes an input sequence to produce a set of context vectors, which are then used by the decoder 454 to generate an output sequence. This architecture may be applied to various tasks including, in the current application, reconstruction of an input to facilitate a comparison between the input and the reconstructed output.

The encoder/decoder neural network in the box 450 includes a masking mechanism 456. The masking mechanism 456 applies a random and dynamic mask to some of the cells of the input STFT matrix 440, thus blanking them out so they are not visible to the encoder 452, which operates only on the set of visible cells or patches. The decoder 454 then processes the full set of encoded patches and mask tokens to reconstruct the input. A masking ratio is chosen to suit application requirements, and may be in a range of 50-80%, or higher or lower as appropriate. Random masking is a technique which helps to overcome overfitting and information redundancy in the encoder/decoder pair. The masking mechanism 456 is shown inside the box of the encoder/decoder neural network 450 because the mask is dynamic, meaning it is randomly generated every iteration when training the encoder/decoder network pair.

The encoder/decoder neural network 450 also includes layer-wise query embedding. The encoder/decoder pair has an architecture which includes various types of layers (e.g., fully-connected layer, convolutional layer, attention layer). A common problem in reconstruction-based anomaly detection is known as the “identical shortcut”, where the neural network layers connect their nodes in a way which enables both normal and anomaly samples to be reconstructed accurately. If an anomaly sample is reconstructed accurately, it will have a small difference between neural network input and output, and hence a low anomaly score (discussed below), which is undesirable. Thus, measures must be taken to minimize the possibility of the identical shortcut. Query embedding can prevent accurately reconstructing anomalies; therefore, a layer-wise query decoder is employed by adding the query embedding in each decoder layer.

Taken together, the STFT at the box 420, the feature jittering at the box 430, the encoder/decoder pair (452/454) with layer-wide query embedding, and the masking mechanism 456 enable the reconstruction-based anomaly detection module 410 to process time-series data for anomaly detection while overcoming known obstacles including the identical shortcut (leading to low scores for anomaly samples) and overfitting.

The input STFT matrix 440 and the reconstructed output STFT matrix 460 are provided to a differencing junction 470, where the reconstructed output STFT matrix 460 is subtracted from the input STFT matrix 440. A difference matrix 480 (D) is the output from the differencing junction 470. At box 490, an anomaly score is computed from the difference matrix 480, in a manner discussed below.

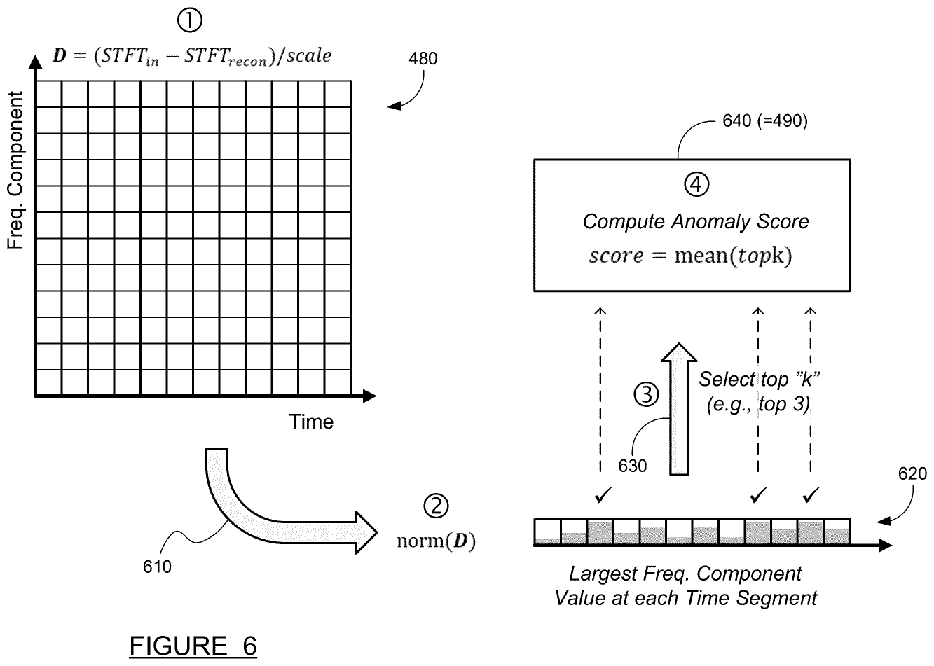

FIG. 6 is an illustration of a technique for computing an anomaly score from a difference between input and reconstructed STFT matrices, according to an embodiment of the present disclosure. The difference matrix 480 (D) from FIG. 4 is shown in step \textcircled{1} at the top left of FIG. 6. The difference matrix 480 is determined from D=(STFTᵢₙ−STFT_{recon})/scale, where STFTᵢₙ is the input STFT matrix 440, STFT_{recon} is the reconstructed output STFT matrix 460, and scale is a scale factor which could have any suitable value based on a desired range of anomaly scores computed in a later step. As discussed earlier, the input STFT matrix 440 contains STFT data (magnitude of each frequency component at each time segment) as input to the encoder/decoder neural network 450, and the reconstructed output STFT matrix 460 contains reconstructed STFT data as output from the encoder/decoder neural network 450. Thus, the difference matrix D (480) reflects how closely the output of the encoder/decoder neural network 450 matches the input.

At a step \textcircled{2} identified by arrow 610, the norm of the difference matrix D (480) is computed. The result of the norm(D) operation is depicted as a vector 620, which contains the largest frequency component value at each time segment. In a step \textcircled{3} identified by arrow 630, the top “k” values from the norm vector 620 are selected. For example, if the value of k is three, then the top 3 values from the norm vector 620 are selected. This is depicted graphically in FIG. 6 by the check marks above the three highest magnitude values in the norm vector 620.

At a step \textcircled{4} in box 640, the anomaly score is computed as the mean of the top “k” values (e.g., the mean of the top 3 values) selected as described above. That is, the score is computed by score=mean(topk). Thus, starting with the difference matrix D at step 1 and combining the operations of steps \textcircled{2}-\textcircled{4}, the anomaly score can be defined as follows:

$$score = mean ( topk ( norm ( D ) ) ) \qquad ( 1 )$$

The anomaly score computed from Equation (1), as shown in box 640 of FIG. 6, corresponds with the score in the box 490 of FIG. 4.

Returning once again to FIG. 4, the encoder/decoder neural network 450 of the reconstruction-based anomaly detection module 410 is trained using a plurality of good data samples to produce a low anomaly score—that is, to produce a reconstructed output STFT matrix 460 which is very similar to the input STFT matrix 440 for good data samples. This training is accomplished by providing the computed anomaly score for each data sample as feedback to the encoder/decoder neural network 450, where over a large number of training samples the neural network 450 learns a node connectivity which results in low anomaly scores for good data samples. The reconstruction-based anomaly detection module 410 with the trained encoder/decoder neural network 450 is then used for a second stage of system configuration, and finally for online time-series data evaluation in inference mode, both of which are discussed further below.

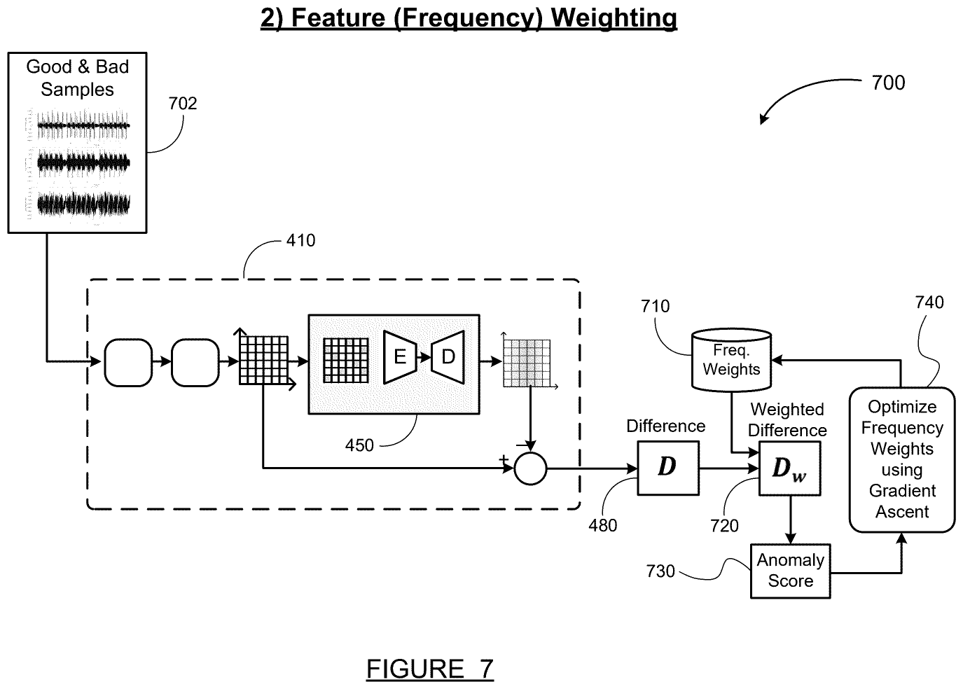

FIG. 7 is a block diagram illustration of an anomaly detection system 700 configured for feature weighting, where both good and bad data samples are provided to the reconstruction-based anomaly detection module 410 of FIG. 4 and feature weights are determined which optimize anomaly score results, according to an embodiment of the present disclosure. Feature weighting is a second stage of system configuration, performed after the encoder/decoder neural network 450 is trained, and before the complete system with the reconstruction-based anomaly detection module 410 and the optimized frequency weights is used for online time-series data evaluation.

Classified data including both known good and known bad (anomaly) data samples are provided at a box 702. In preferred embodiments, a larger number of good data samples and a smaller number of anomaly data samples are provided. The reconstruction-based anomaly detection module 410 including the encoder/decoder neural network 450, described in detail with respect to FIG. 4, are shown here in FIG. 7 at a reduced level of detail. The encoder/decoder neural network 450 was trained as discussed above, and is not further trained in the feature/frequency weighting step of FIG. 7.

The reconstruction-based anomaly detection module 410 provides the difference matrix 480, as discussed earlier. However, rather than computing the anomaly score directly from the difference matrix 480, a frequency weight database 710 is used to create a weighted difference matrix 720 (identified symbolically as D_{w}), which is then used for computing the anomaly score. The values of the weights in the frequency weight database 710 will be optimized in the configuration step shown in FIG. 7.

Continuing with the example discussed earlier, consider the case where the STFT input matrix 440 and the reconstructed output matrix 460 each have 50 time segments (on the horizontal axis) and 128 frequency components (on the vertical axis) for a particular time-series sample. Thus, these matrices and the difference matrix 480 have a size of 128 rows by 50 columns. If data from X, Y and Z axis accelerometers is processed, each in its own time-series sample and each having its own STFT matrix, then three difference matrices 480 will be produced, each having dimensions 128×50. The STFT frequency components can be concatenated into an overall difference matrix D having dimensions 384×50—where the X, Y and Z frequency components are stacked on top of each other for each time segment column.

In this example then, the frequency weights contained in the database 710 are represented as a vector w with dimension 384×1. That is, the vector w (which is initially populated with all 1's) is multiplied by the respective frequency component values in the difference matrix D (480) to produce the weighed difference matrix D_{w} (720).

Using the technique illustrated in FIG. 6 and discussed earlier, an anomaly score is computed at box 730 from the weighed difference matrix D_{w} (720) rather than from the original difference matrix D (480). This computation is done using Equation (1) with D_{w} substituted for D.

Box 740 represents a gradient ascent optimizer which operates in a loop with the frequency weight database 710, the weighed difference matrix D_{w} (720) and the anomaly score computation box 730. The gradient ascent optimizer works as follows. For each iteration (processing anomaly scores for a plurality of good and bad time-series data samples), the gradient ascent algorithm finds a gradient in the weight vector space which increases the difference between good and bad sample anomaly scores.

According to the techniques of the present disclosure, a weight is assigned to each frequency component of the difference matrix being evaluated, and the weighted difference is used. An initial weight value of 1.0 is assigned to each of the 384 frequency components, and an iterative optimization process is employed where the anomaly scores are recomputed using a weighted difference matrix and the gradient ascent computation adjusts the frequency weights to maximize a gap between good and bad time-series sample anomaly scores.

As explained above, it is necessary to process a plurality of time-series data samples—including both known good and known bad samples—at each iteration step. The good sample anomaly scores and the bad sample anomaly scores are then stored in the box 740 and used for the gradient ascent computation.

The gradient ascent computation is performed to update the individual frequency weight values in the weight vector w. As known in the art, gradient ascent is an iterative technique which may be used to evaluate the effect of a set of input variables on a value of a function, and follow the gradient to maximize the function. In this case, the gradient ascent calculation is defined as:

$$w = w + α ∇ g \qquad ( 2 )$$

Where Equation (2) updates the weight vector w by adding a term which is the learning rate factor α multiplied by a gradient ∇ of the function g. The value of g is the value of the anomaly scores for bad data samples minus the value of the anomaly scores for good data samples. Thus, the value of the function g is greatest when the anomaly scores of bad data samples are higher and the anomaly scores of good data samples are lower. At each iteration, a local value of the gradient ∇ is established, and following iterations will use the value of the gradient to calculate a next iteration of the weight vector w according to Equation (2). The result is that the weight vector w is updated in the direction of positive gradient, and ultimately an optimal weight vector w is found which maximizes g.

The iteration continues until either the gradient converges to a predefined convergence criteria or a predefined maximum number of iterations is reached. The convergence criteria and the maximum number of iterations may be defined as suitable for a given application.

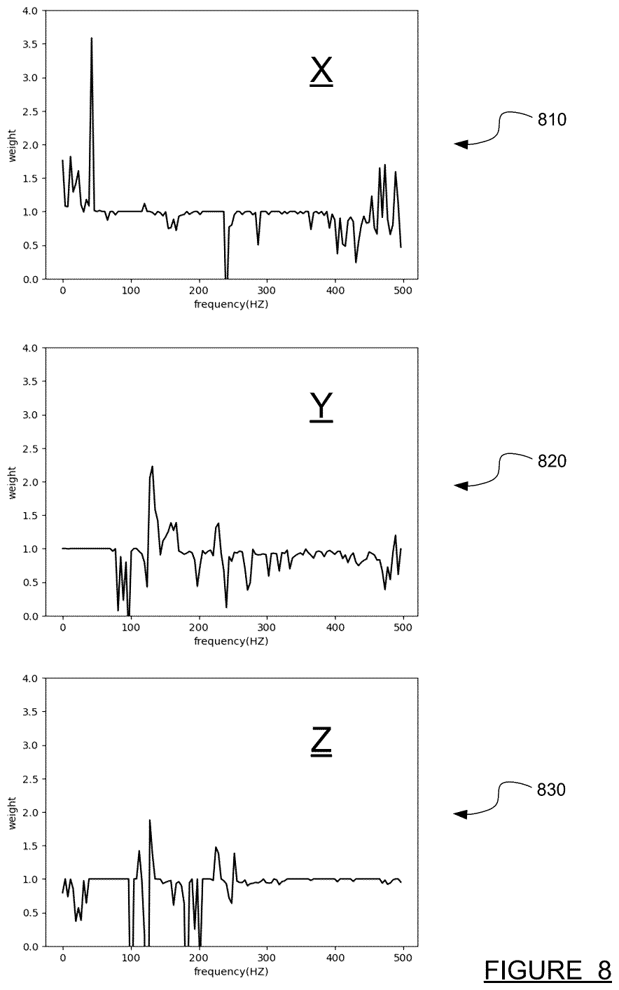

FIG. 8 includes graphs of frequency weights for X, Y and Z time-series data signals as determined by the feature weighting technique depicted in FIG. 7, according to an embodiment of the present disclosure. A graph 810 plots the frequency weights for each of the 128 frequency components of the X axis accelerometer time-series data sets. A graph 820 plots the frequency weights for each of the 128 frequency components of the Y axis accelerometer time-series data sets. A graph 830 plots the frequency weights for each of the 128 frequency components of the Z axis accelerometer time-series data sets.

As discussed above with respect to FIG. 7, the gradient ascent optimization technique has adjusted each of the 384 frequency weights in the weight vector w so as to maximize the separation between good and bad anomaly scores. Each of the graphs 810, 820 and 830 has a general trend line at a weight value of 1.0, with some weights higher and some weights lower. Weight values which were set greater than 1.0 in the gradient ascent optimization represent frequency components which are important for distinguishing good time-series data from bad (anomaly) time-series data. Weight values which were set lower than 1.0 in the gradient ascent optimization represent noisy frequency components which are detrimental to accurate anomaly detection.

The feature/frequency weighting depicted in FIGS. 7 and 8 has been demonstrated to be highly effective in tuning the disclosed time-series anomaly detection system. Frequency weighting for use in anomaly score computation is an effective means of separating good time-series data from bad time-series data, even when any anomaly present in bad time-series samples is not detectable visually or via other analysis techniques. Furthermore, the gradient ascent technique described above enables automatic and efficient frequency weight optimization. FIG. 8 clearly shows that it would be impossible to effectively select the individual frequency weight values in any manual method. Computational selection of frequency weights one at a time is also ineffective because of the interdependencies of the hundreds of frequency weights in calculating anomaly scores.

Frequency weights can be optimized as described above for a particular type of time-series data (e.g., a particular machine tool operating on certain types of parts), and then the trained encoder/decoder neural network and optimized frequency weights used for analysis of online production data. If time-series data for a different type of operation is to be analyzed, the encoder/decoder neural network training and frequency optimization would need to be performed using time-series data samples for that particular type of operation.

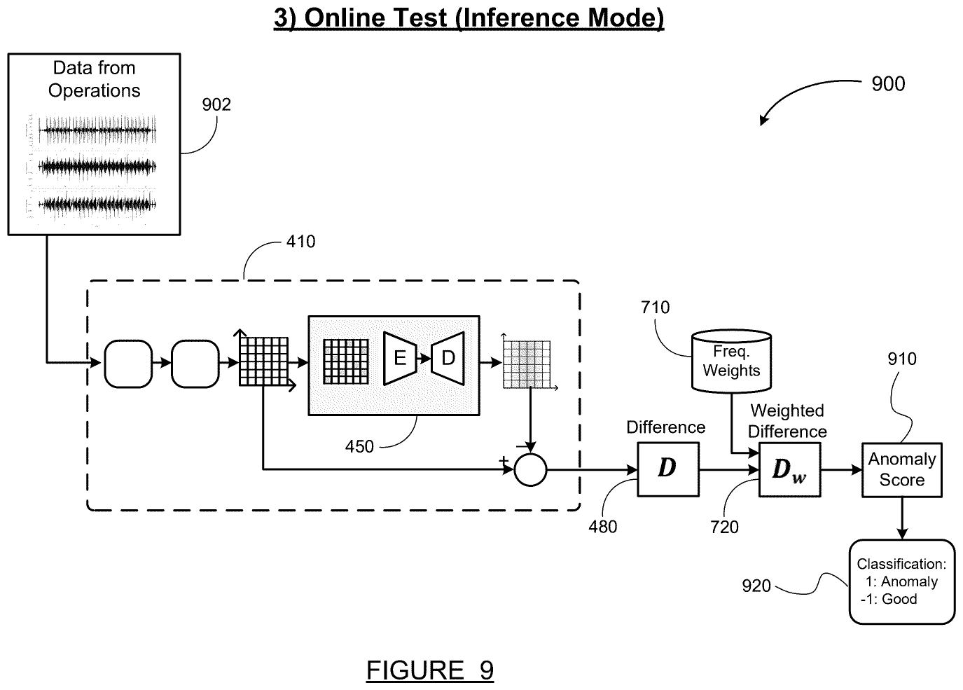

FIG. 9 is a block diagram illustration of an anomaly detection system 900 configured for online testing in inference mode, where operational data samples are provided to the trained anomaly detection module of FIG. 4 and optimized frequency weights are used to determine an anomaly score and a classification, according to an embodiment of the present disclosure.

Time-series data samples from “production” operations are provided at a box 902. That is, the time-series data samples provided at the box 902 are of unknown classification-they may represent normal operations, or they may represent anomaly operations. Each data sample (or set of three X/Y/Z data samples) is evaluated using the system 900 in online test (inference) mode to determine whether operations are normal or anomalous.

The reconstruction-based anomaly detection module 410 including the encoder/decoder neural network 450, described in detail with respect to FIG. 4, are shown here in FIG. 9 at a reduced level of detail. The encoder/decoder neural network 450 was trained as discussed above, and is not further trained. The frequency weight database 710, with the final values of the weight vector w after gradient ascent optimization, is used in FIG. 9.

The reconstruction-based anomaly detection module 410 provides the difference matrix 480, as discussed earlier. The frequency weight database 710 is used to create the weighted difference matrix 720 (D_{w}), which is then used for computing the anomaly score of the unknown-quality time-series data sample at a box 910. The anomaly score computation at the box 910 is the same as discussed earlier with respect to FIG. 6, using Equation (1) applied to the weighted difference D_{w}; the box 910 is given a new number for FIG. 9 simply because it is computing an anomaly score for unclassified time-series data.

At box 920, the time-series data sample is classified as either good or anomaly based on the anomaly score from the box 910. Typically, an anomaly score threshold is predefined, and any time-series data sample resulting in an anomaly score above the threshold is classified as an anomaly. Data samples scoring below the threshold are classified as good. Classification values of one for anomaly and negative one for good are sometimes used in anomaly detection systems, as shown in the box 920.

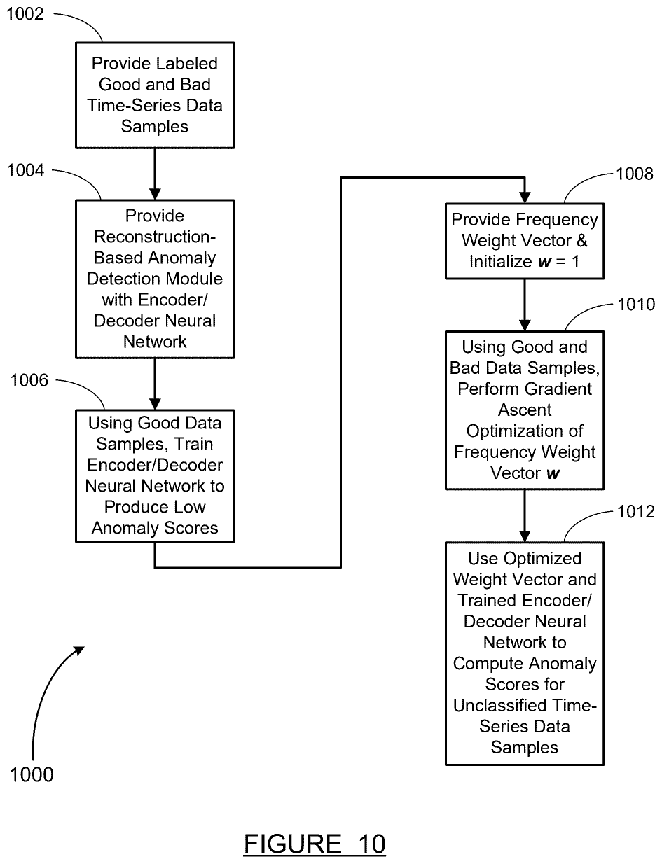

FIG. 10 is a flowchart diagram 1000 of a method for reconstruction-based time-series anomaly detection, including training an encoder/decoder neural network and optimizing frequency weights used for computing an anomaly score, according to embodiments of the present disclosure.

At box 1002, labeled time-series data samples are provided, including both good samples and bad samples which will be selectively used as discussed. At box 1004, a reconstruction-based anomaly detection module is provided. This is the reconstruction-based anomaly detection module 410 of FIG. 4—including a short time Fourier transform (STFT) algorithm and a feature jittering function resulting in the input STFT matrix 440, and the encoder/decoder neural network 450 which processes the input STFT matrix 440 and provides a reconstructed output STFT matrix 460. The encoder/decoder neural network 450 includes the random masking mechanism 456 and the layer-wise query embedding features as discussed earlier. The reconstruction-based anomaly detection module 410 produces a difference matrix between the input and reconstructed STFT matrices, from which an anomaly score is calculated, as also discussed earlier.

At box 1006, the encoder/decoder neural network 450 is trained to produce low anomaly scores for good time-series data samples. This is a supervised learning operation, as discussed earlier, where the anomaly score computed from the difference matrix is provided as learning feedback to effect the desired encoder/decoder neural network training.

At box 1008, a frequency weight vector w is provided and initialized as all values equal one. At box 1010, using both good and bad time-series data samples, the frequency weight vector w is optimized using gradient ascent, as depicted in FIG. 7 and discussed above. That is, the weight vector w is used to computed a weighted difference matrix D_{w} which is in turn used to calculate anomaly scores, and anomaly scores for a plurality of samples (both good and bad) are used in the iterative gradient ascent optimization. The gradient ascent optimization yields values of the weight vector w which maximize the difference between good sample anomaly scores and bad sample anomaly scores.

At box 1012, the optimized frequency weight vector and the trained encoder/decoder neural network are used to compute anomaly scores for unclassified time-series data samples. This is the inference mode of the system depicted in FIG. 9, where unclassified (unknown good or bad) data from operations is processed through the reconstruction-based anomaly detection module 410 to produce a difference matrix, and the optimized weight vector is applied to provide a weighted difference matrix D_{w}, from which an anomaly score is computed and the data sample is classified.

Tests of a reconstruction-based anomaly detection system trained as described above—including both encoder/decoder neural network training and frequency weighting for anomaly score computation-yielded outstanding anomaly detection results characteristics in recall (few missed anomaly detections) and in precision (few false anomaly classifications), compared to existing anomaly detection techniques. The disclosed application of reconstruction-based anomaly detection to time-series data, including the short time Fourier transform and the corresponding difference matrix scoring, provides anomaly detection capability which fulfills a previously unmet need.

Throughout the preceding discussion, various computers are described and implied. It is to be understood that the software applications and modules of these computers are executed on one or more computing devices having a processor and a memory module. In particular, this includes computer(s) with processor(s) configured with algorithms performing the functions of the blocks in FIGS. 4-7 and 9, where the computer(s) may be in communication with the controller 390 of FIG. 3 for example, as needed to effect a fully automated anomaly detection system.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A method for reconstruction-based time-series anomaly detection, said method comprising:
performing a short time Fourier transform (STFT) on time-series data samples to provide an input STFT matrix;
providing the input STFT matrix to an encoder/decoder neural network which computes a reconstructed output STFT matrix;
multiplying a frequency weight vector by a difference between the input STFT matrix and the output STFT matrix to produce a weighted difference matrix; and
computing an anomaly score for the time-series data samples from the weighted difference matrix.

2. The method according to claim 1 wherein the input STFT matrix, the output STFT matrix and the weighted difference matrix each comprise a plurality of frequency component magnitudes for each of a plurality of time segments.

3. The method according to claim 1 wherein a feature jittering operation is performed on the input STFT matrix before it is provided to the encoder/decoder neural network.

4. The method according to claim 1 wherein the encoder/decoder neural network includes a random masking mechanism applied before an encoder module, and includes layer-wise query embedding.

5. The method according to claim 1 wherein the encoder/decoder neural network is trained using supervised learning by computing the anomaly score for a plurality of pre-classified good time-series data samples and providing the anomaly score as feedback for neural network learning.

6. The method according to claim 5 wherein the supervised learning includes a penalty or reinforcement which causes the encoder/decoder neural network to produce low anomaly scores for the good time-series data samples.

7. The method according to claim 5 wherein the frequency weight vector has all values set equal to one during the supervised learning of the encoder/decoder neural network.

8. The method according to claim 1 wherein values in the frequency weight vector are determined by performing a gradient ascent optimization, including computing anomaly scores for a plurality of pre-classified time-series data samples comprising both good and bad samples, and iteratively adjusting the values in the frequency weight vector and re-computing the anomaly scores to maximize a difference between the anomaly scores of the good and bad samples.

9. The method according to claim 8 wherein the gradient ascent optimization of the frequency weight vector is performed after the encoder/decoder neural network is trained to produce low anomaly scores for good time-series data samples.

10. The method according to claim 1 wherein the anomaly score is computed by taking a norm of the weighted difference matrix to obtain a vector having a largest frequency component for each time segment, selecting a quantity of elements of the vector having a greatest value, and calculating the anomaly score as a mean of the quantity of elements having the greatest value.

11. The method according to claim 1 wherein anomaly scores are computed for unclassified time-series data samples after the encoder/decoder neural network is trained to produce low anomaly scores for good time-series data samples and the values in the frequency weight vector are optimized to maximize a difference between the anomaly scores of the good and bad samples, where the unclassified time-series data samples are classified as an anomaly when their anomaly score is above a predefined threshold.

12. The method according to claim 1 wherein the time-series data samples include one or more of torque data from a spindle motor of a machine tool, speed data from the spindle motor, and/or data from one or more axial accelerometers mounted on the machine tool.

13. A method for reconstruction-based time-series anomaly detection, said method comprising:
performing a short time Fourier transform (STFT) on time-series data samples to provide an input STFT matrix;
providing the input STFT matrix to an encoder/decoder neural network which computes a reconstructed output STFT matrix;
multiplying a frequency weight vector by a difference between the input STFT matrix and the output STFT matrix to produce a weighted difference matrix, where the input STFT matrix, the output STFT matrix and the weighted difference matrix each comprise a plurality of frequency component magnitudes for each of a plurality of time segments; and
computing an anomaly score for the time-series data samples from the weighted difference matrix,
where the encoder/decoder neural network is trained using supervised learning by computing the anomaly score for a plurality of pre-classified good time-series data samples and providing the anomaly score as feedback for neural network learning,
and where values in the frequency weight vector are determined by performing a gradient ascent optimization, including computing anomaly scores for a plurality of pre-classified time-series data samples comprising both good and bad samples, and iteratively adjusting the values in the frequency weight vector and re-computing the anomaly scores to maximize a difference between the anomaly scores of the good and bad samples,
and anomaly scores are computed for unclassified time-series data samples after the encoder/decoder neural network is trained and the values in the frequency weight vector are optimized.

14. A reconstruction-based time-series anomaly detection system, said system comprising:
a computer having a processor and memory configured with;
a reconstruction-based anomaly detection module which performs a short time Fourier transform (STFT) on time-series data samples and provides an input STFT matrix to an encoder/decoder neural network which computes a reconstructed output STFT matrix;
a frequency weight database including a frequency weight vector which is multiplied by a difference between the input STFT matrix and the output STFT matrix to produce a weighted difference matrix; and
an anomaly score computation algorithm which computes an anomaly score for the time-series data samples from the weighted difference matrix.

15. The system according to claim 14 wherein the input STFT matrix, the output STFT matrix and the weighted difference matrix each comprise a plurality of frequency component magnitudes for each of a plurality of time segments.

16. The system according to claim 14 wherein a feature jittering operation is performed on the input STFT matrix before it is provided to the encoder/decoder neural network, and where the encoder/decoder neural network includes a random masking mechanism applied before an encoder module and includes layer-wise query embedding.

17. The system according to claim 14 wherein the encoder/decoder neural network is trained using supervised learning by computing the anomaly score for a plurality of pre-classified good time-series data samples and providing the anomaly score as feedback for neural network learning, where the supervised learning includes a penalty or reinforcement which causes the encoder/decoder neural network to produce low anomaly scores for the good time-series data samples.

18. The system according to claim 17 wherein the frequency weight vector has all values set equal to one during the supervised learning of the encoder/decoder neural network.

19. The system according to claim 14 wherein values in the frequency weight vector are determined by performing a gradient ascent optimization, including computing anomaly scores for a plurality of pre-classified time-series data samples comprising both good and bad samples, and iteratively adjusting the values in the frequency weight vector and re-computing the anomaly scores to maximize a difference between the anomaly scores of the good and bad samples.

20. The system according to claim 19 wherein the gradient ascent optimization of the frequency weight vector is performed after the encoder/decoder neural network is trained to produce low anomaly scores for good time-series data samples.

21. The system according to claim 14 wherein the anomaly score is computed by taking a norm of the weighted difference matrix to obtain a vector having a largest frequency component for each time segment, selecting a quantity of elements of the vector having a greatest value, and calculating the anomaly score as a mean of the quantity of elements having the greatest value.

22. The system according to claim 14 wherein anomaly scores are computed for unclassified time-series data samples after the encoder/decoder neural network is trained to produce low anomaly scores for good time-series data samples and the values in the frequency weight vector are optimized to maximize a difference between the anomaly scores of the good and bad samples, where the unclassified time-series data samples are classified as an anomaly when their anomaly score is above a predefined threshold.

23. The system according to claim 14 wherein the time-series data samples include one or more of torque data from a spindle motor of a machine tool, speed data from the spindle motor, and/or data from one or more axial accelerometers mounted on the machine tool.

24. The system according to claim 23 data from concurrent time-series data samples containing acceleration data measured in three principle directions on the machine tool are processed concurrently, including concatenating frequency component data from all of the concurrent time-series data samples into a combined weighted difference matrix and computing the anomaly score from the combined weighted difference matrix.
